(19) United States
(12) Patent Application Publication
(10) Pub. No.: US 2015/0375974 A1
(43) Pub. Date: Dec. 31, 2015

(54) STABILIZER LEGS FOR KNUCKLEBOOM LOADER

(71) Applicant: Caterpillar Forest Products Inc., Peoria, IL (US)

(72) Inventor: James L. Kramer, Phillips, WI (US)

(21) Appl. No.: 14/316,941

(22) Filed: Jun. 27, 2014

(51) Int. Cl. B66C 23/78; A01G 23/097; B60S 9/02

(52) U.S. Cl. CPC B66C 23/78; B60S 9/02; A01G 23/097

(57) ABSTRACT

A knuckleboom loader including four stabilizer legs to stabilize a knuckleboom loader and counter tipping forces acting on the knuckleboom loader. A rear first stabilizer leg extends away from the knuckleboom loader. A rear second stabilizer leg opposing the rear first stabilizer leg extends away from the knuckleboom loader. A front first stabilizer leg extends away from the knuckleboom loader. The front first stabilizer leg extends further away from the knuckleboom loader than the rear first stabilizer leg. The knuckleboom loader further includes a front second stabilizer leg opposing the front first stabilizer leg. The front second stabilizer leg extends further away from the knuckleboom loader than the rear second stabilizer leg.

### TECHNICAL FIELD

The present disclosure relates to a knuckleboom loader and more particularly to stabilizer legs for a knuckleboom loader in combination with a delimber.

### BACKGROUND

Knuckleboom loaders are used in forestry applications to process trees. Conventionally, knuckleboom loaders typically include a frame, stabilizing legs, a boom, a stick, and a grapple. One end of the boom is connected to the frame. The other end of the boom provides for connection with the stick. The grapple is located distally from the boom and connected at an opposing end of the stick. The boom and the stick allow positioning of the grapple relative to the frame while the grapple can be articulated about its connection with the stick.

The grapple may also include one or more jaws that are operable to open or close while processing trees i.e., while picking or placing the trees from or at a specified location. For example, the knuckleboom loader may be used to feed trees into delimbers that remove tree branches. While processing trees or picking/placing other objects, the knuckleboom loader may become unstable due to increased tipping forces. In order to help counterbalance the tipping forces, knuckleboom loaders often include a support system with stabilizing legs. However, support systems often require extra supporting legs that may restrict workspace and create work hazards—rendering the systems ineffective in operation. For example, Chinese Patent No. CN102582590A relates to a supporting system for an engineering machine that includes a first supporting leg, a second supporting leg, a third supporting leg, a fourth supporting leg, and additional supporting legs arranged between the third supporting leg and the fourth supporting leg.

### SUMMARY

In one aspect, the present disclosure provides a knuckleboom loader including four stabilizer legs. A rear first stabilizer leg extends away from the knuckleboom loader. A rear second stabilizer leg opposing the rear first stabilizer leg extends away from the knuckleboom loader. A front first stabilizer leg extends away from the knuckleboom loader. The front first stabilizer leg extends further away from the knuckleboom loader than the rear first stabilizer leg. The knuckleboom loader further includes a front second stabilizer leg opposing the front first stabilizer leg. The front second stabilizer leg extends further away from the knuckleboom loader than the rear second stabilizer leg.

In another aspect, the present disclosure provides a delimbing system that includes a delimber and a knuckleboom loader for delivering trees to the delimber. The delimbing system further includes a stabilizing system associated with the knuckleboom loader. The stabilizing system includes a rear first stabilizer leg extending away from the knuckleboom loader. The knuckleboom loader also includes a rear second stabilizer leg extending away from the knuckleboom loader. The rear second stabilizer leg opposes the rear first stabilizer leg. The stabilizing system further includes a front first stabilizer leg extending away from the knuckleboom loader. The font first stabilizer leg extends further away from the knuckleboom loader than the rear first stabilizer leg. The stabilizing system also includes a front second stabilizer leg opposing the front first stabilizer leg. The front second stabilizer leg extends further away from the knuckleboom loader than the rear second stabilizer leg.

In yet another aspect, the present disclosure provides a knuckleboom loader including a rear first stabilizer leg extending away from the knuckleboom loader and a front first stabilizer leg extending away from the knuckleboom loader. The front first stabilizer leg is parallel to the rear first stabilizer leg and extends further away from the knuckleboom loader than the rear first stabilizer leg. The knuckleboom loader also includes a rear second stabilizer leg extending away from the knuckleboom loader and a front second stabilizer leg extending away from the knuckleboom loader. The front first stabilizer leg is parallel to the rear second stabilizer leg and extends further away from the knuckleboom loader than the rear second stabilizer leg.

Other features and aspects of this disclosure will be apparent from the following description and the accompanying drawings.

### BRIEF DESCRIPTION OF THE DRAWINGS

FIG. 1 is a side perspective view of an exemplary knuckleboom loader positioning a tree into a delimber in which embodiments of the present disclosure can be implemented;

FIG. 2 is a diagram representation of the knuckleboom loader and the knives of the delimber in an open position;

FIG. 3 is a diagram representation of the knuckleboom loader and the knives of the delimber in a closed position around the tree;

FIG. 4 is a top view of the knuckleboom loader showing the stabilizing legs extending perpendicular to the knuckleboom frame;

FIG. 5 is a top view of the knuckleboom loader showing the front stabilizing legs extending perpendicular to a tipping plane; and

FIG. 6 is a top view of the knuckleboom loader showing the front stabilizing legs extending at a forward angle towards a tipping plane.

While the disclosure is susceptible to various modifications and alternative forms, specifics have been shown by way of example in the drawings and will be described in detail below. It should be understood that the detailed description is not to limit aspects of the disclosure to the particular embodiments described. On the contrary, the disclosure covers all modifications, equivalents, and alternatives falling within the spirit and scope of the disclosure.

### DETAILED DESCRIPTION

The present disclosure relates to a delimbing system including stabilizing legs for a knuckleboom loader equipped with a delimber. Wherever possible the same reference numbers will be used throughout the drawings to refer to the same or like parts. Moreover, references to various elements described herein are made collectively or individually when there may be more than one element of the same type. However, such references are merely exemplary in nature. Accordingly, it may be noted that any such reference to elements in the singular is also to be construed to relate to the plural and vice-versa without limiting the scope of the disclosure to the exact number or type of such elements unless set forth explicitly in the appended claims.

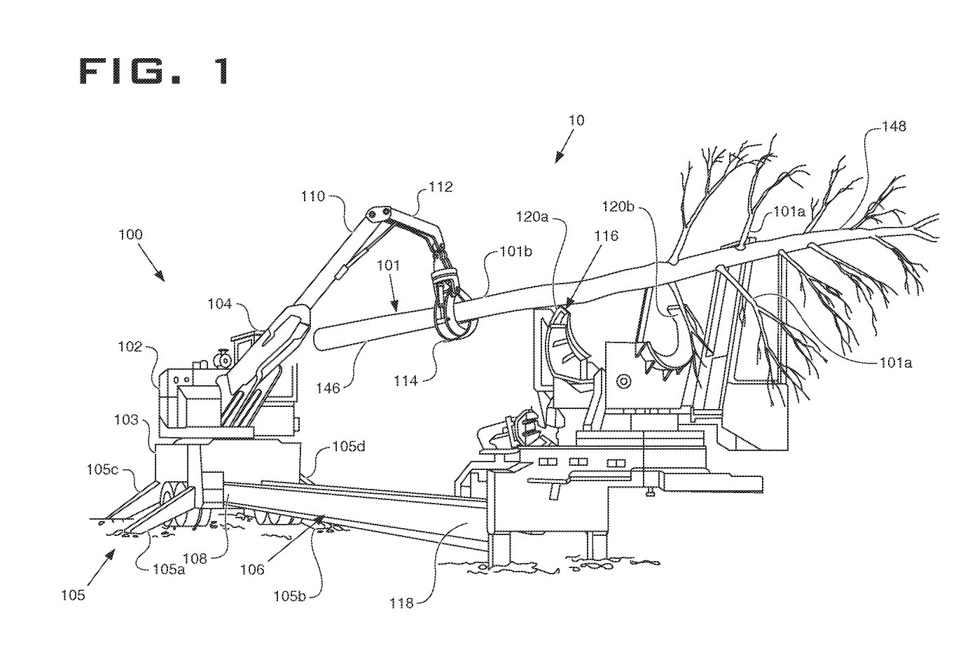

FIG. 1 shows a diagram view of an exemplary delimbing system 10 including a knuckleboom loader 100 pivotally mounted on a frame 103 having stabilizing legs 105 (also referred to as a stabilizing system 105). The stabilizing legs 105 may be hydraulically actuated. The stabilizing legs 105 include front first stabilizer leg 105a, front second stabilizer leg 105b, rear first stabilizer leg 105c, and rear second stabilizer leg 105d. The front first stabilizer leg 105a opposes the front second stabilizer leg 105b. The rear first stabilizer leg 105c opposes the rear second stabilizer leg 105d. Frame 103 may be bolted onto a trailer 106. As illustrated in FIG. 1, the knuckleboom loader 100 is used to perform operations such as, but not limited to, hauling, sorting, processing, slashing, and loading of trees 101 that have been cut down by other machines. During operation, the stabilizing legs 105 help counterbalance (offset) tipping forces created by the additional load of trees 101.

The knuckleboom loader 100 includes a prime mover 102 and a cab 104 mounted on the frame 103. As shown in FIG. 1, the prime mover 102 and the cab 104 are mounted at a first end 108 of the trailer 106. The cab 104 is provided to house an operator (not shown) of the knuckleboom loader 100. Moreover, the cab 104 includes control implements that are operable for controlling the knuckleboom loader 100.

The prime mover 102 may be a fuel-based engine that powers the knuckleboom loader 100 by combustion of natural resources, such as diesel gasoline, liquid natural gas, or other petroleum products. However, in alternative embodiments, the present disclosure may be equally implemented by way of using an electric motor in lieu of the engine.

The knuckleboom loader 100 further includes a boom 110, a stick 112, and a grapple 114 mounted in sequence to the frame 103. As such, the cab 104 and the boom 110 can be swiveled on top of the frame 103. Additionally, the boom 110 can be operated to pivot vertically with respect to the frame 103. The stick 112 can be vertically hoisted or lowered relative to the boom 110. The boom 110 and the stick 112 facilitate movement of the grapple 114 in various planes relative to the frame 103. Further, the grapple 114 can be articulated about its connection with the stick 112 thus, being capable of changing its orientation depending on specific requirements of an application. Therefore, the boom 110, the stick 112, and the grapple 114 impart dexterity to the knuckleboom loader 100 for executing operations such as loading, hauling, sorting, slashing, and and/or processing trees 101. Moreover, during operation the tipping forces of the knuckleboom loader 100 may vary—as will be described in further detail below.

The knuckleboom loader 100 further includes a delimber 116 mounted at a second end 118 of the trailer 106. The delimber 116 includes a knife 120 (two knives 120a, 120b shown in the embodiment of FIG. 1). However, in alternative embodiments, more than two knives, for example, three, four, five, or more knives can be included in the delimber 116 depending on the type of delimber and/or specific requirements of an application. The knives 120a, 120b can be operated to open or shut against a trunk 101b of the tree 101 in accordance with the embodiments of the disclosure.

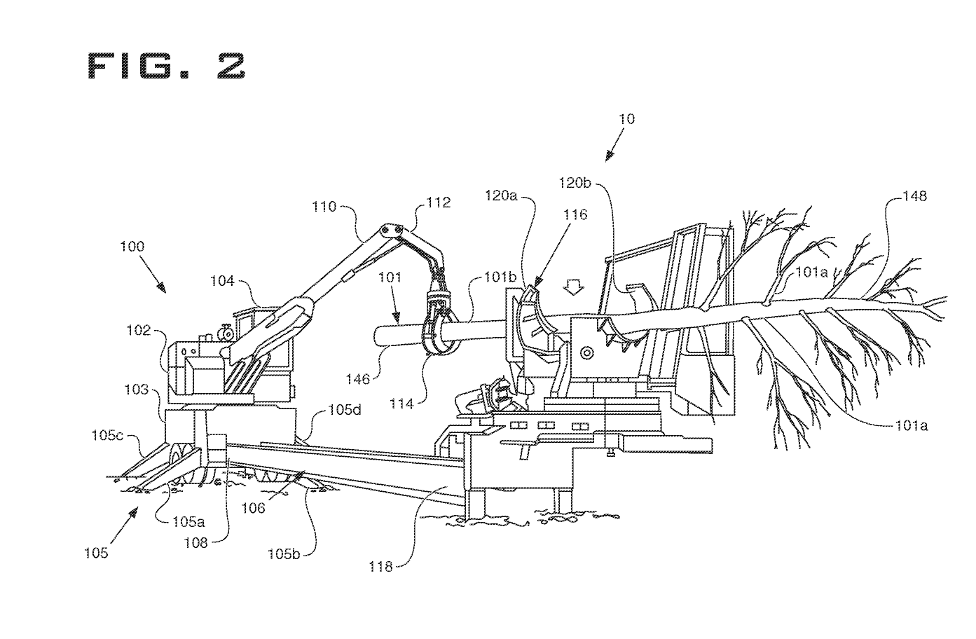

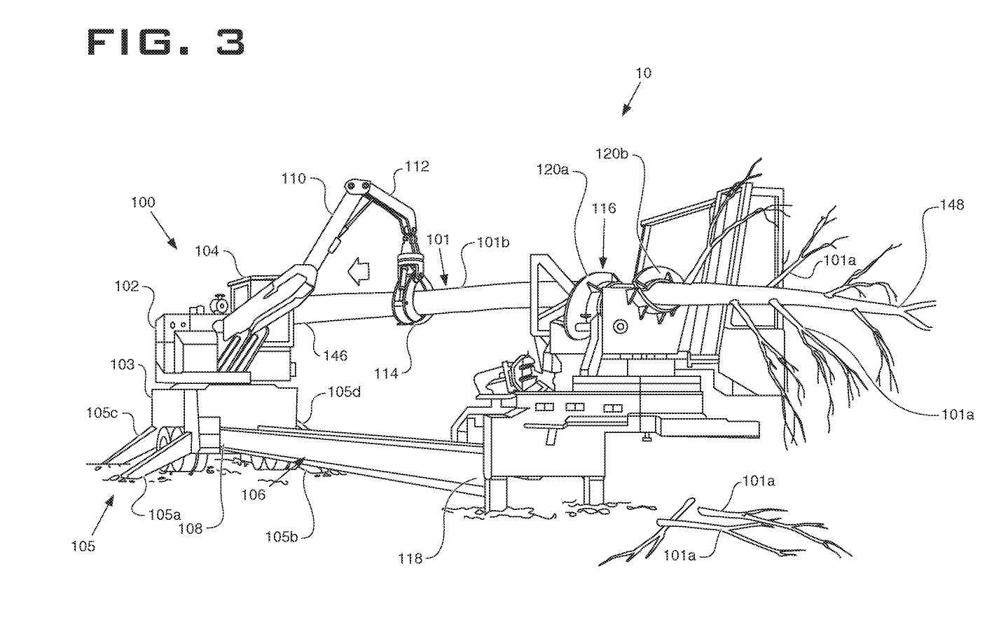

As depicted in FIG. 2, during operation, the knives 120a, 120b are opened, and the grapple 114 is used to place tree 101 between the knives 120a, 120b. It should be noted that the grapple 114 continues to hold the trunk 101b of the tree 101 after placing it between the knives 120a, 120b. As depicted in FIG. 3, the knives 120a, 120b are shut against the trunk 101b of the tree 101. The grapple 114 is then used to pull the trees 101 through the closed knives 120a, 120b such that branches 101a of the tree 101 are severed and separated from the trunk 101b. It is common knowledge that trees come in a variety of sizes and shapes. Moreover, in softwood logging applications, i.e. pertaining mostly to wood from pine and fir trees, it has been seen that a circumference of the trunk 101b typically decreases upwards or reduces gradually from a base 146 to a top portion 148 of the trunk 101b, i.e., the base 146 of the trunk 101b typically has a larger circumference or girth as compared to a top portion 148 of the trunk 101b. In other embodiments, a toping saw (not shown) may be used to process the trees 101.

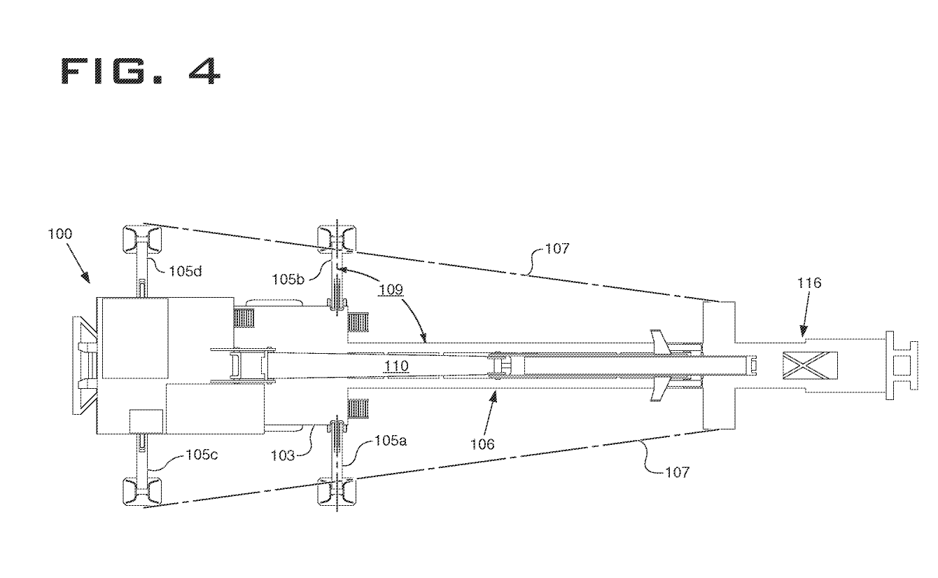

FIG. 4 is a top view of the knuckleboom loader 100 showing the stabilizing legs 105 extending perpendicular to the frame 103 and towards a tipping plane 107. The tipping plane 107 being defined as a line from the rear stabilizing legs to the second end 118 of the trailer 106. Front first stabilizer leg 105a extends further from the frame 103 of knuckleboom loader 100 than rear first stabilizer leg 105c and is parallel to rear first stabilizer leg 105c. In some embodiments, front first stabilizer leg 105a extends at least 3 inches (7.6 centimeters) further away from frame 103 than the rear first stabilizer leg 105c. In other embodiments, front first stabilizer leg 105a extends at least 6 inches (15 centimeters) further away from frame 103 than the rear first stabilizer leg 105c. In some embodiments, front first stabilizer leg 105a extends between 3 inches (7.6 centimeters) and 24 inches (61 centimeters) further away from frame 103 than the rear first stabilizer leg 105c. In other embodiments, front first stabilizer leg 105a extends between 6 inches (15 centimeters) and 24 inches (61 centimeters) further away from frame 103 than the rear first stabilizer leg 105c.

Front second stabilizer leg 105b opposes front first stabilizer leg 105a and is parallel to rear second stabilizer leg 105d. Front second stabilizer leg 105b extends further from the frame 103 of knuckleboom loader 100 than rear second stabilizer leg 105d. In some embodiments, front second stabilizer leg 105b extends at least 3 inches (7.6 centimeters) further away from frame 103 than the rear second stabilizer leg 105d. In other embodiments, front second stabilizer leg 105b extends at least 6 inches (15 centimeters) further away from frame 103 than the rear second stabilizer leg 105d. In some embodiments, front second stabilizer leg 105b extends between 3 inches (7.6 centimeters) and 24 inches (61 centimeters) further away from frame 103 than the rear second stabilizer leg 105d. In other embodiments, front second stabilizer leg 105b extends between 6 inches (15 centimeters) and 24 inches (61 centimeters) further away from frame 103 than the rear second stabilizer leg 105d. In some embodiments, front second stabilizer leg 105b extends the same distance away from frame 103 as front first stabilizer leg 105a—both distances being further away from frame 103 than rear first stabilizer leg 105c and rear second stabilizer leg 105d.

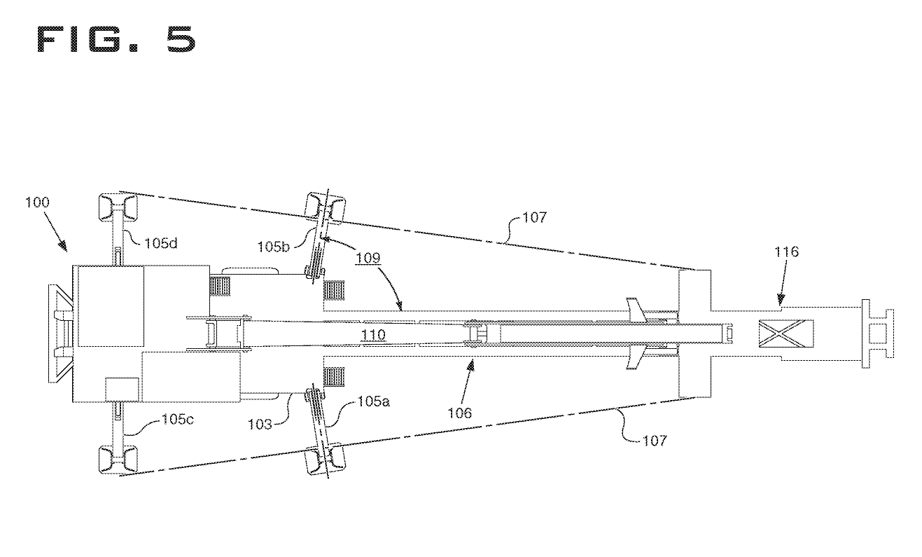

FIG. 5 is a top view of the knuckleboom loader 100 showing front first stabilizer leg 105a and front second stabilizer leg 105b extending perpendicular to tipping plane 107. When positioned perpendicular to tipping plane 107, front first stabilizer leg 105a extends at least 3 inches (7.6 centimeters) further away from frame 103 than the rear first stabilizer leg 105c. In other embodiments, when positioned perpendicular to tipping plane 107, front first stabilizer leg 105a extends at least 6 inches (15 centimeters) further away from frame 103 than the rear first stabilizer leg 105c. In some embodiments, when positioned perpendicular to tipping plane 107, front first stabilizer leg 105a extends between 3 inches (7.6 centimeters) and 24 inches (61 centimeters) further away from frame 103 than the rear first stabilizer leg 105c. In other embodiments, when positioned perpendicular to tipping plane 107, front first stabilizer leg 105a extends between 6 inches (15 centimeters) and 24 inches (61 centimeters) further away from frame 103 than the rear first stabilizer leg 105c.

When positioned perpendicular to tipping plane 107, front second stabilizer leg 105b opposes front first stabilizer leg 105a. Front second stabilizer leg 105b extends further from the frame 103 of knuckleboom loader 100 than rear second stabilizer leg 105d. In some embodiments, when positioned perpendicular to tipping plane 107, front second stabilizer leg 105b extends at least 3 inches (7.6 centimeters) further away from frame 103 than the rear second stabilizer leg 105d. In other embodiments, when positioned perpendicular to tipping plane 107, front second stabilizer leg 105b extends at least 6 inches (15 centimeters) further away from frame 103 than the rear second stabilizer leg 105d. In some embodiments, when positioned perpendicular to tipping plane 107, front second stabilizer leg 105b extends between 3 inches (7.6 centimeters) and 24 inches (61 centimeters) further away from frame 103 than the rear second stabilizer leg 105d. In other embodiments, when positioned perpendicular to tipping plane 107, front second stabilizer leg 105b extends between 6 inches (15 centimeters) and 24 inches (61 centimeters) further away from frame 103 than the rear second stabilizer leg 105d. In some embodiments, when positioned perpendicular to tipping plane 107, front second stabilizer leg 105b extends the same distance away from frame 103 as front first stabilizer leg 105a—both distances being further away from frame 103 than rear first stabilizer leg 105c and rear second stabilizer leg 105d.

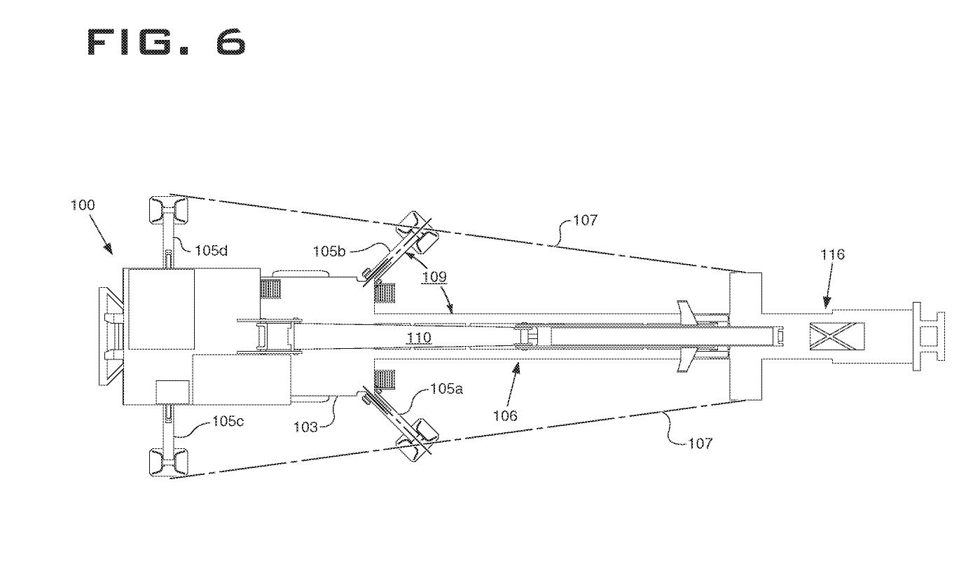

FIG. 6 is a top view of the knuckleboom loader 100 showing front first stabilizer leg 105a and front second stabilizer leg 105b extending at a forward angle 109 towards tipping plane 107. The stabilizer legs 105 may articulate at various angles. In some embodiments, front first stabilizer leg 105a extends at an angle 109 equal to or greater than 45 degrees away from frame 103. In some embodiments, when angled away from frame 103, front first stabilizer leg 105a extends at least 3 inches (7.6 centimeters) further away from frame 103 than the rear first stabilizer leg 105c. In other embodiments, when angled away from frame 103, front first stabilizer leg 105a extends at least 6 inches (15 centimeters) further away from frame 103 than the rear first stabilizer leg 105c. In some embodiments, when angled away from frame 103, front first stabilizer leg 105a extends between 3 inches (7.6 centimeters) and 24 inches (61 centimeters) further away from frame 103 than the rear first stabilizer leg 105c. In other embodiments, when angled away from frame 103, front first stabilizer leg 105a extends between 6 inches (15 centimeters) and 24 inches (61 centimeters) further away from frame 103 than the rear first stabilizer leg 105c.

When angled away from frame 103, front second stabilizer leg 105b opposes front first stabilizer leg 105a. Front second stabilizer leg 105b extends further from the frame 103 of knuckleboom loader 100 than rear second stabilizer leg 105d at an angle 109 equal to or greater than 45 degrees away from frame 103. In some embodiments, when angled away from frame 103, front second stabilizer leg 105b extends at least 3 inches (7.6 centimeters) further away from frame 103 than the rear second stabilizer leg 105d. In other embodiments, when angled away from frame 103, front second stabilizer leg 105b extends at least 6 inches (15 centimeters) further away from frame 103 than the rear second stabilizer leg 105d. In some embodiments, when angled away from frame 103, front second stabilizer leg 105b extends between 3 inches (7.6 centimeters) and 24 inches (61 centimeters) further away from frame 103 than the rear second stabilizer leg 105d. In other embodiments, when angled away from frame 103, front second stabilizer leg 105b extends between 6 inches (15 centimeters) and 24 inches (61 centimeters) further away from frame 103 than the rear second stabilizer leg 105d. In some embodiments, when angled away from frame 103, front second stabilizer leg 105b extends the same distance away from frame 103 as front first stabilizer leg 105a—both distances being further away from frame 103 than rear first stabilizer leg 105c and rear second stabilizer leg 105d.

A method for stabilizing a knuckleboom loader 100 may include identifying tipping plane 107 for the knuckleboom loader 100. The method further includes extending the rear first stabilizer leg 105c and the front first stabilizer leg 105a away from the knuckleboom loader 100 and towards the tipping plane 107. The front first stabilizer leg 105a extends further than the rear first stabilizer leg 105c. The method also includes extending a rear second stabilizer leg 105d and a front second stabilizer leg 105b away from the knuckleboom loader 100 and towards the tipping plane 107. The front second stabilizer leg 105b extends further than the rear second stabilizer leg 105d. In some embodiments, the method may further include extending the front first stabilizer leg 105a and the front second stabilizer leg 105b perpendicular to the tipping plane 107. In other embodiments, the method may include extending the front first stabilizer leg 105a and the front second stabilizer leg 105b at an angle 109 between 45 degrees and 90 degrees away from the frame 103 of knuckleboom loader 100. It is contemplated that specific circumstances may require the stabilizer legs to extend past 90 degrees away from the frame 103 of knuckleboom loader 100. In addition, the stabilizing legs may be positioned at different angles from one another.

Although the present disclosure discloses that the knuckleboom loader 100 is part of a delimbing system 10, the knuckleboom loader 100 and stabilizing legs 105 may be part of a stand-alone knuckleboom loader 100. In addition, it is contemplated that the knuckleboom loader 100 may be part of a truck mounted assembly. One of ordinary skill in the art will appreciate that the staging and delimbing process may be beneficially implemented by way of using the stand-alone knuckleboom loader 100 depending on specific requirements of a forestry application. Therefore, various combinations of the parts disclosed herein may be contemplated and such combinations can be implemented without deviating from the spirit of the present disclosure.

### INDUSTRIAL APPLICABILITY

The knuckleboom loader 100 and stabilizing legs 105 of the present disclosure have applicability for implementation and use in industrial settings such as forestry, agriculture, construction and the like.

In some cases, the stabilizing legs 105 of the present disclosure can be used to stabilize a knuckleboom loader 100 and counter tipping forces acting on the knuckleboom loader 100. In other cases, the stabilizing legs 105 can altogether prevent the knuckleboom loader 100 from tipping over. Moreover, the stabilizing legs 105 of the present disclosure allow a knuckleboom loader 100 to stage material such as trees 101 without tipping over due to increased stability. As disclosed herein, extending the front first stabilizer leg 105a and the front second stabilizer leg 105b further away from the frame 103 of knuckleboom loader 100 than the rear first stabilizer leg 105c and rear second stabilizer leg 105d—increases lift capability through improved stability. The distance or angle 109 of such extensions may vary depending on an identified tipping plane 107. By only lengthening the front first stabilizer leg 105a and the front second stabilizer leg 105b, the stability of the knuckleboom loader 100 is increased while still allowing the rear first stabilizer leg 105c and the rear second stabilizer leg 105d to fit under the frame 103.

The present configuration of the stabilizing legs 105 allows a manufacturer to do away with use of additional counterweights or other means for increasing stability—such as additional stabilizing legs. As a result, costs associated with manufacture and operation of the present knuckleboom loader 100 can be less than that incurred with use of previously known systems. Moreover, the increased stability resulting from the present configuration allows manufacturers of knuckleboom loaders and delimbing systems to achieve improved functionality with use of minimal components.

Modifications to embodiments of the present disclosure described in the foregoing are possible without departing from the scope of the present disclosure as defined by the accompanying claims.

What is claimed is:

1. A knuckleboom loader, comprising:
a rear first stabilizer leg extending away from the knuckleboom loader;
a rear second stabilizer leg opposing the rear first stabilizer leg, wherein the rear second stabilizer leg extends away from the knuckleboom loader;
a front first stabilizer leg extending away from the knuckleboom loader, wherein the front first stabilizer leg extends further away from the knuckleboom loader than the rear first stabilizer leg; and
a front second stabilizer leg opposing the front first stabilizer leg, wherein the front second stabilizer leg extends away from the knuckleboom loader, and wherein the front first stabilizer leg extends further away from the knuckleboom loader than the rear second stabilizer leg.

2. The knuckleboom loader of claim 1, wherein the front first stabilizer leg extends at an angle perpendicular to a tipping plane of the knuckleboom loader.

3. The knuckleboom loader of claim 1, wherein the front second stabilizer leg extends at an angle perpendicular to a tipping plane of the knuckleboom loader.

4. The knuckleboom loader of claim 1, wherein the knuckleboom loader includes a frame, and wherein the front first stabilizer leg and the front second stabilizer leg extend perpendicular to the frame.

5. The knuckleboom loader of claim 1, wherein the knuckleboom loader includes a frame, and wherein the front first stabilizer leg and the front second stabilizer leg extend away from the frame at an angle equal to or greater than 45 degrees.

6. The knuckleboom loader of claim 1, wherein the front stabilizer legs extend a distance of at least 3 inches (7.6 centimeters) further away from the knuckleboom loader than the rear stabilizer legs extend away from the knuckleboom loader.

7. The knuckleboom loader of claim 1, wherein the front stabilizer legs extend a distance between 3 inches (7.6 centimeters) and 24 inches (61 centimeters) further away from the knuckleboom loader than the rear stabilizer legs.

8. A delimbing system, comprising:
a delimber;
a knuckleboom loader for delivering trees to the delimber;
a stabilizing system associated with the knuckleboom loader, wherein the stabilizing system comprises:
a rear first stabilizer leg extending away from the knuckleboom loader;
a rear second stabilizer leg opposing the rear first stabilizer leg and extending away from the knuckleboom loader;
a front first stabilizer leg extending away from the knuckleboom loader, wherein the front first stabilizer leg extends further away from the knuckleboom loader than the rear first stabilizer leg; and
a front second stabilizer leg opposing the front first stabilizer leg and extending away from the knuckleboom loader, wherein the front second stabilizer leg extends further away from the knuckleboom loader than the rear second stabilizer leg.

9. The delimbing system of claim 8, wherein the front first stabilizer leg extends at an angle perpendicular to a tipping plane of the knuckleboom loader.

10. The delimbing system of claim 8, wherein the front second stabilizer leg extends at an angle perpendicular to a tipping plane of the knuckleboom loader.

11. The delimbing system of claim 8, wherein the knuckleboom loader includes a frame, and wherein the front first stabilizer leg and the front second stabilizer leg extend perpendicular to the frame.

12. The delimbing system of claim 8, wherein the knuckleboom loader includes a frame, and wherein the front first stabilizer leg and the front second stabilizer leg extend away from the frame towards the delimber at an angle equal to or greater than 45 degrees.

13. The delimbing system of claim 8, wherein the front stabilizer legs extend a distance of at least 3 inches (7.6 centimeters) further away from the knuckleboom loader than the rear stabilizer legs.

14. The delimbing system of claim 8, wherein the front stabilizer legs extend a distance between 3 inches (7.6 centimeters) and 24 inches (61 centimeters) further away from the knuckleboom loader than the rear stabilizer legs.

15. A knuckleboom loader, comprising:
a rear first stabilizer leg extending away from the knuckleboom loader;
a front first stabilizer leg extending away from the knuckleboom loader, wherein the front first stabilizer leg is parallel to the rear first stabilizer leg and extends further away from the knuckleboom loader than the rear first stabilizer leg;
a rear second stabilizer leg extending away from the knuckleboom loader; and
a front second stabilizer leg extending away from the knuckleboom loader, wherein the front first stabilizer leg is parallel to the rear second stabilizer leg and extends further away from the knuckleboom loader than the rear second stabilizer leg.

16. The knuckleboom loader of claim 15, wherein the front first stabilizer leg extends at an angle perpendicular to a frame of the knuckleboom loader.

17. The knuckleboom loader of claim 15, wherein the front second stabilizer leg extends at an angle perpendicular to a frame of the knuckleboom loader.

18. The knuckleboom loader of claim 15, wherein the front stabilizer legs extend a distance of at least 3 inches (7.6 centimeters) further away from the knuckleboom loader than the rear stabilizer legs extend away from the knuckleboom loader, wherein the front first stabilizer leg, front second stabilizer leg, rear first stabilizer leg, and rear second stabilizer leg are perpendicular to a frame of the knuckleboom loader.

19. The knuckleboom loader of claim 15, wherein the front stabilizer legs extend a distance between 3 inches (7.6 centimeters) and 24 inches (61 centimeters) further away from the knuckleboom loader than the rear stabilizer legs extend away from the knuckleboom loader, wherein the front first stabilizer leg, front second stabilizer leg, rear first stabilizer leg, and rear second stabilizer leg are perpendicular to a frame of the knuckleboom loader.

20. The knuckleboom loader of claim 15, wherein the front stabilizer legs extend a distance between 6 inches (15 centimeters) and 24 inches (61 centimeters) further away from the knuckleboom loader than the rear stabilizer legs extend away from the knuckleboom loader, wherein the front first stabilizer leg, front second stabilizer leg, rear first stabilizer leg, and rear second stabilizer leg are perpendicular to a frame of the knuckleboom loader.
